(19) United States
(12) Patent Application Publication
(10) Pub. No.: US 2026/0340430 A1
(43) Pub. Date: Oct. 29, 2026

(54) INFORMATION PROCESSING APPARATUS, METHOD AND PROGRAM

(71) Applicant: NTT, Inc., Tokyo (JP)

(72) Inventors: Chao WU, Musashino-shi (JP); Shingo HORIUCHI, Musashino-shi (JP); Hiroaki KIKUSHIMA, Musashino-shi (JP); Nobukazu FUKUDA, Musashino-shi (JP); Kenichi TAYAMA, Musashino-shi (JP)

(73) Assignee: NTT, Inc., Tokyo (JP)

(21) Appl. No.: 19/115,256

(22) PCT Filed: Sep. 27, 2022
(86) PCT No.: PCT/JP2022/035943

§ 371 Date: Mar. 26, 2025

(51) Int. Cl. G06N 5/022; G06Q 50/26; G08B 7/06

(52) U.S. Cl. CPC G06N 5/022; G08B 7/06; G06Q 50/265

(57) ABSTRACT

The information processing apparatus according to the present embodiment includes an analysis unit, a search unit, and a determination unit. The analysis unit analyzes the intention of the user. The search unit searches for a node corresponding to the analysis result of the intention in a knowledge graph in which a service, a service target to which the service is to be implemented, and an orchestrator related to operation management of the service and the service target are respectively represented as nodes in different hierarchies and a relationship between nodes in different hierarchies or between nodes in the same hierarchy is represented as an edge. The determination unit determines the type and the value of a service and a resource based on the intention of the user by referring to the knowledge graph with reference to the corresponding node.

### TECHNICAL FIELD

The present invention relates to an information processing apparatus, a method and a program for determining a resource requirement required for a service.

### BACKGROUND ART

With diversification of types of services and advancement of provided services, it is regarded as more important to dynamically provide services in accordance with intention (intent) of users. Configurations and requirements of a service and a resource need to be determined in accordance with intention of the user.

For determining such a configuration and a requirement, a necessary service and a necessary resource are determined by a method determined for each service in a conventional method (see, for example, Non Patent Literature 1).

### CITATION LIST

### Non Patent Literature

Non Patent Literature 1: W. Chao and S. Horiuchi, “Intent-based cloud service management, ” 2018 21st Conference on Innovation in Clouds, Internet and Networks and Workshops (ICIN), 2018, pp. 1-5, doi: 10.1109/ICIN.2018.8401600.

### SUMMARY OF INVENTION

### Technical Problem

As described above, the conventional method has a problem that it takes time to develop a service, since it is necessary to consider and implement a method of determining a configuration and a requirement of a resource each time a service is developed.

The present invention has been made in view of the above circumstances, and an object thereof is to provide an information processing apparatus, a method and a program capable of efficiently developing a service according to intention of the user in a short period of time.

### Solution to Problem

In order to achieve the above object, an information processing apparatus according to an aspect of the present invention includes an analysis unit, a search unit, and a determination unit. The analysis unit analyzes the intention of the user. The search unit searches for a node corresponding to the analysis result of the intention in a knowledge graph in which a service, a service target to which the service is to be implemented, and an orchestrator related to operation management of the service and the service target are respectively represented as nodes in different hierarchies and a relationship between nodes in different hierarchies or between nodes in the same hierarchy is represented as an edge. The determination unit determines the type and the value of a service and a resource based on the intention of the user by referring to the knowledge graph with reference to the corresponding node.

### Advantageous Effects of Invention

According to the present invention, a service according to intention of the user can be efficiently developed in a short period of time.

### BRIEF DESCRIPTION OF DRAWINGS

FIG. 1 is a block diagram of an information processing apparatus according to the present embodiment.

FIG. 2 is a diagram illustrating a knowledge graph according to the present embodiment.

FIG. 3 is a flowchart illustrating an example of service requirement determination processing by the information processing apparatus according to the present embodiment.

FIG. 4 is a diagram illustrating an example of a dialog indicating exchange between a user and a chatbot.

FIG. 5 is a diagram illustrating an example of an analysis result of intention of the user for the dialog illustrated in FIG. 4.

FIG. 6 is a diagram illustrating a knowledge graph of a cloud domain to be searched.

FIG. 7 is a diagram illustrating an example of a determination result of a service requirement and a value thereof based on the knowledge graph illustrated in FIG. 6.

FIG. 8 is a diagram illustrating a knowledge graph of an IoT domain to be searched.

FIG. 9 is a diagram illustrating an example of a determination result of a service requirement and a value thereof based on the knowledge graph illustrated in FIG. 8.

FIG. 10 is a diagram illustrating an example of an operation flow by an orchestrator for which a service requirement is set.

### DESCRIPTION OF EMBODIMENTS

Hereinafter, an information processing apparatus, a method, and a program according to an embodiment of the present disclosure will be described in detail with reference to the drawings. Note that, in the following embodiment, similar operation is performed for portions denoted by the same reference numerals, and redundant description will be omitted.

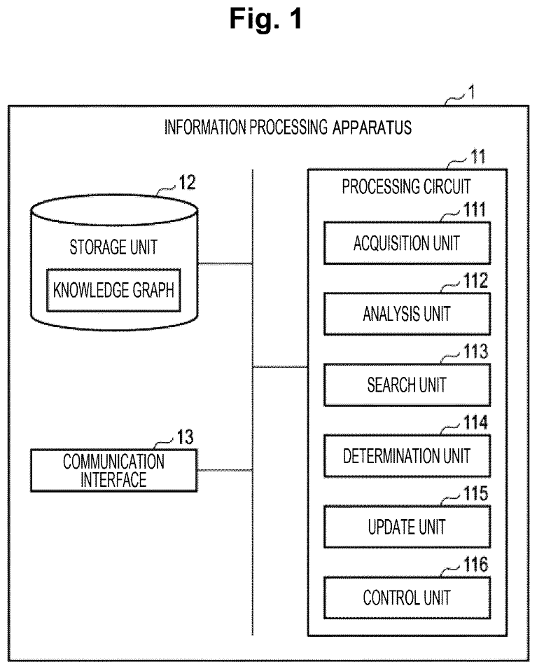

An information processing apparatus according to the present embodiment will be described with reference to a block diagram of FIG. 1.

An information processing apparatus 1 illustrated in FIG. 1 includes a processing circuit 11, a storage unit 12, and a communication interface 13. The processing circuit 11 includes an acquisition unit 111, an analysis unit 112, a search unit 113, a determination unit 114, an update unit 115, and a control unit 116.

The acquisition unit 111 acquires utterance of the user or character information inputted by the user. For example, the acquisition unit 111 may acquire interaction between the user and a chatbot. In the case of acquiring utterance of the user, a voice input may be accepted by a microphone or the like, the utterance of the user may be subjected to voice recognition processing by general voice recognition processing, and a character string that is a voice recognition result may be acquired. Note that the present invention is not limited to collecting utterance of the user by the chatbot, and any acquisition mode may be adopted as long as it is possible to acquire and collect the intention of the user, such as selecting a certain item by the user from a pull-down menu screen displayed on a display.

The analysis unit 112 analyzes the intention (intent) of the user from the utterance of the user and the character information inputted by the user acquired by the acquisition unit 111. In the present embodiment, the intention of the user includes an instruction by the user.

The search unit 113 searches for a node corresponding to the analysis result of the intention of the user in the knowledge graph. The knowledge graph is a graph in which a service, a service target, and an orchestrator are respectively represented as nodes in different hierarchies, and a relationship between nodes in different hierarchies or between nodes in the same hierarchy is represented as an edge. The service is a service provided in a domain. The service target indicates a characteristic content of a service, or a characteristic group. Specifically, in a case where there is a service called a remote medical interview, “hospital” that provides the remote medical interview is a service target. The orchestrator is a function of centrally performing operation management of a service or the like in each domain.

The determination unit 114 refers to the knowledge graph with reference to the corresponding node to determine the types and the values of the service and the resource based on the intention of the user. Note that requirements related to the service and the resource are also collectively referred to as service requirements.

The update unit 115 updates the knowledge graph. Specifically, the update unit 115 updates the nodes and edges of the knowledge graph in accordance with addition or change of a service or a service target, or change of a requirement of a resource.

The control unit 116 controls an operation related to the entire information processing apparatus 1. For example, an inquiry to the user is executed.

The storage unit 12 stores, for example, information regarding intention of the user and a plurality of knowledge graphs created on the basis of a common creation criterion for each domain.

The communication interface 13 is an interface for Communicating with an external device such as a server or an Internet of Things (IoT) device. Communication with an external device may be wireless or wired.

Note that the processing circuit 11 of the information processing apparatus 1 includes a processor such as a central processing unit (CPU) or a graphics processing unit (GPU), or an integrated circuit such as a field programmable gate array (FPGA) or an application specific integrated circuit (ASIC). Each unit of the processing circuit 11 described above may be implemented as one function of a processor or an integrated circuit by the processor or the integrated circuit executing a processing program stored in the storage unit 12, for example.

The storage unit 12 of the information processing apparatus 1 includes, for example, a generally used storage medium such as a hard disk drive (HDD), a solid state drive (SSD), or a flash memory.

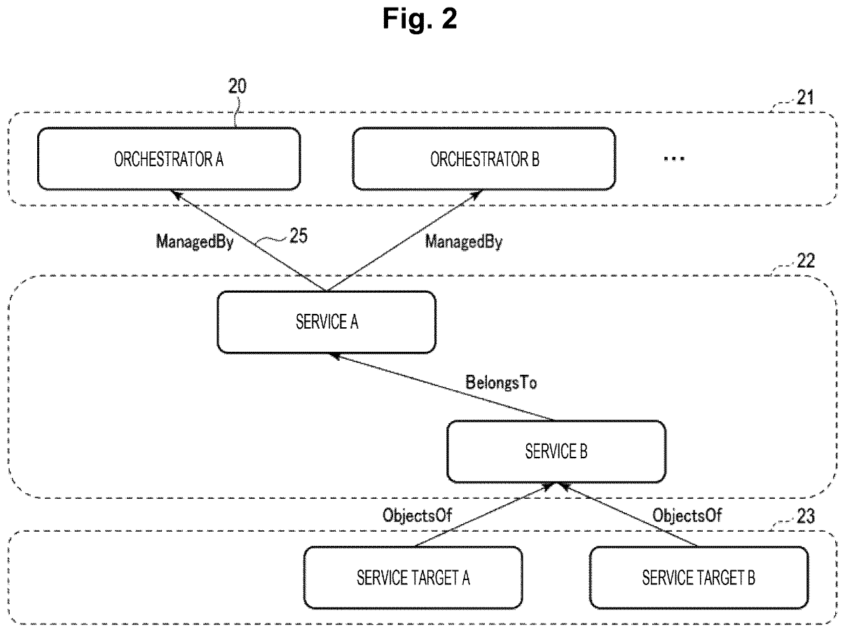

Next, an example in which the domain management function according to the present embodiment is represented by a knowledge graph will be described with reference to FIG. 2.

The knowledge graph illustrated in FIG. 2 illustrates a configuration of a skeleton common to domains. Each of the management functions of the service, the service target, and the orchestrator in the domain is represented as a knowledge graph node 20. Here, an orchestrator 21 is disposed at the highest layer, and includes an orchestrator A and an orchestrator B in the example in FIG. 2. A service 22 is disposed as a lower layer of the orchestrator 21, and includes a service A and a service B here. A service target 23 is disposed as a lower layer of the service 22, and includes a service target A and a service target B here.

Moreover, the service requirement of the service 22 and the service requirement of the service target 23 are represented as attributes of the nodes 20. Specifically, requirements such as, for example, a security level, a network delay, the data amount, the priority, and a network slice type may be represented as an attribute (which is also referred to as a node attribute) of the node 20 related to the service 22 or the service target 23.

Regarding the orchestrator 21, a design (template) readable by the orchestrator is represented as an attribute. For example, a slice template, a protocol, and an application programming interface (API) may be represented as the attribute of the orchestrator 21.

Note that other entities accompanied with the domain may also be represented as nodes 20 of the knowledge graph.

Furthermore, the hierarchical relationship of services in the service 22, the relationship with the resource, the relationship with the orchestrator 21, and the relationship with the management target are represented as an edge 25 connecting nodes 20 of the knowledge graph. For example, the relationship between the service target 23 and the service 22 is represented by an edge 25 of “ObjectsOf”. In a case where there is a hierarchical relationship between the services 22, it is represented by an edge 25 of “BelongsTo” indicating that a lower service type belongs to a higher-level service type. The relationship between the service 22 and the orchestrator 21 is represented as “ManagedBy” indicating that the service 22 is managed by the orchestrator 21.

Note that there may be a hierarchical relationship not only between the services 22 but also between the orchestrators 21 or between the service targets 23. Moreover, other relationships belonging to the domain may also be represented as the edge 25 of the knowledge graph.

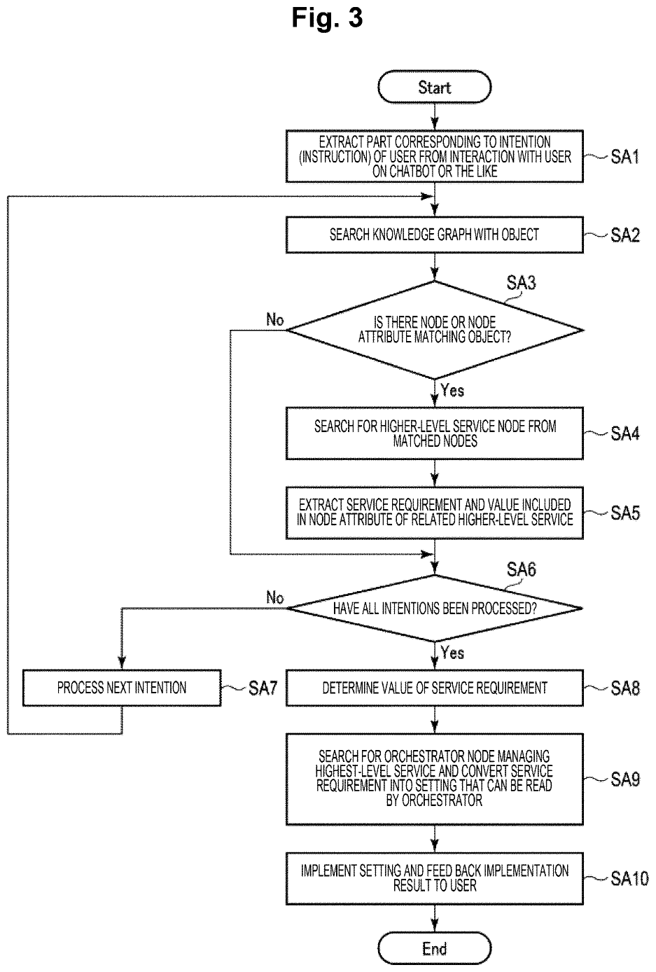

Next, service requirement determination processing by the information processing apparatus 1 according to the present embodiment will be described with reference to the flowchart of FIG. 3. Here, it is assumed that the intention of the user is collected from interaction between the user and the chatbot. Moreover, it is assumed that the knowledge graph according to the domain is generated in advance. For the creation of the knowledge graph, a general method may be used, and the knowledge graph may be generated for each of a plurality of domains related to a service using neo4j (registered trademark) capable of Creating a graph database, for example.

In step SA1, the acquisition unit 111 acquires interaction between the user and the chatbot. In a case where the user is making interaction by utterance, a character string subjected to voice recognition processing is acquired, while in a case where the user is making interaction by keyboard input, an inputted character string is acquired. Thereafter, the analysis unit 112 extracts one or more parts corresponding to the intention of the user from the acquired character string. Specifically, a predicate and an object in the character string representing the intention of the user are extracted. The processing of extracting a part corresponding to an instruction, and the processing of extracting a predicate and an object may use a learned model related to language processing trained in advance. The extraction processing may be executed with a learned model using spaCy and Bidirectional Encoder Representations from Transformers (BERT) as the learned model, for example. Since a general training method may be used as the training method with a learned model for executing the extraction processing of the part corresponding to the instruction and a learned model for executing the extraction processing of the predicate and the object, a detailed description thereof will be omitted.

In step SA2, the search unit 113 searches the knowledge graph with the extracted object. Note that the search target is not limited to the object, and may include other words such as proper nouns or a relationship between words. Moreover, search may be performed by normalizing words having similar meanings to node representations on the knowledge graph. For example, since “University”, “College”, and “Uni.” are words having similar meanings, the representations of “College” and “Uni.” may be normalized to “University”, and “University” may be searched on the knowledge graph in a case where the node “University” exists in the knowledge graph.

In step SA3, the search unit 113 determines whether there is one node or node attribute matching the object or not. Note that, in a case where it is not an exact match, or in a case where a plurality of nodes is obtained as a search result, the control unit 116 may inquire of the user whether a matched node or node attribute is correct or not, or an optimum node from a plurality of nodes, for example. If it is determined that there is one node matching the object, the process proceeds to step SA4, while if it is determined that there is no node matching the object, the process proceeds to step SA6.

In step SA4, the search unit 113 searches for a node related to a higher-level service from matching nodes.

In step SA5, the determination unit 114 extracts a service requirement and a value thereof included in the node attribute of the node related to a higher-level service related to the node determined to match in step SA4, which are the search result. The calculated service requirement and the value thereof may be recorded in the storage unit 12, for example. Note that, in a case where the service requirement and the method of calculating the value are included as the node attribute, the determination unit 114, for example, may determine the value of the service requirement in accordance with the calculation method and record the calculated value in the storage unit 12.

In step SA6, the search unit 113, for example, determines whether all intentions of the user extracted in step SA1 have been processed or not. If all intentions have been processed, the process proceeds to step SA8, while if there is an unprocessed intention, the process proceeds to step SA7.

In step SA7, the search unit 113, for example, selects one of unprocessed intentions extracted in step SA1, and similarly executes the processing from step SA2 to step SA5 for said intention.

In step SA8, the determination unit 114 determines the value of the service requirement. Note that, in a case where a plurality of values of the service requirement of the node related to the higher-level service is calculated, a value with the highest request may be determined as the value of the service requirement.

In step SA9, the search unit 113 searches for the node of the orchestrator that manages the service of the domain, located in the highest layer. The service requirement calculated in step SA8 by the determination unit 114 and the value thereof are converted into setting that can be read by the orchestrator. For example, a service requirement obtained at a node related to a service may be converted to be applied to an input template to the orchestrator.

In step SA10, the control unit 116, for example, causes the orchestrator to read the setting obtained by the conversion, thereby implementing a service based on the intention of the user in the domain. The control unit 116 may make an inquiry for obtaining consent of the user before reading the setting in the orchestrator. Moreover, the control unit 116 may feed back an implementation result to the user.

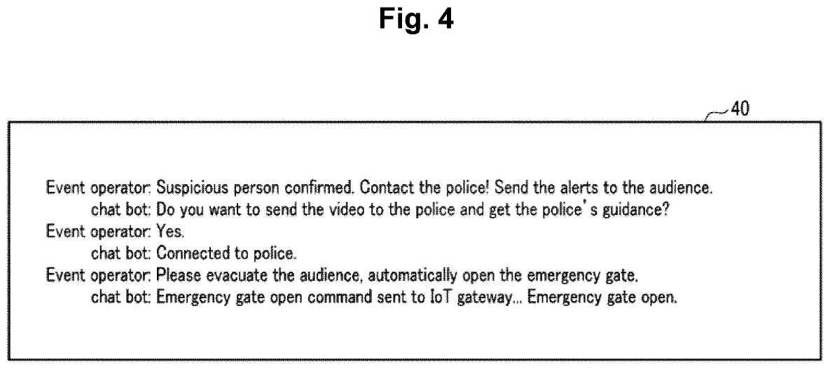

Next, a specific example of the service requirement determination processing by the information processing apparatus 1 according to the present embodiment will be described with reference to FIGS. 4 to 10.

FIG. 4 is a dialog 40 illustrating exchange between the user and the chatbot. As a premise, an event operator has already contracted a service with a telecommunication carrier for watching a sports game. An example is illustrated in which intention based on exchange as illustrated in the dialog 40 is thereafter estimated, and a further service is started on demand in addition to the contracted service. Note that the present invention is not limited to execution of the service on demand from the dialog after service contract, and the service requirement determination processing by the information processing apparatus 1 may be executed by the user directly designating the intention. As a result, the service can be registered and provisioned in advance.

In summary, the contents of the dialog 40 are contents of executing processing such as opening an evacuation gate in response to an accident in cooperation with the police and security guards due to a security accident such as appearance of a suspicious person during a sports game.

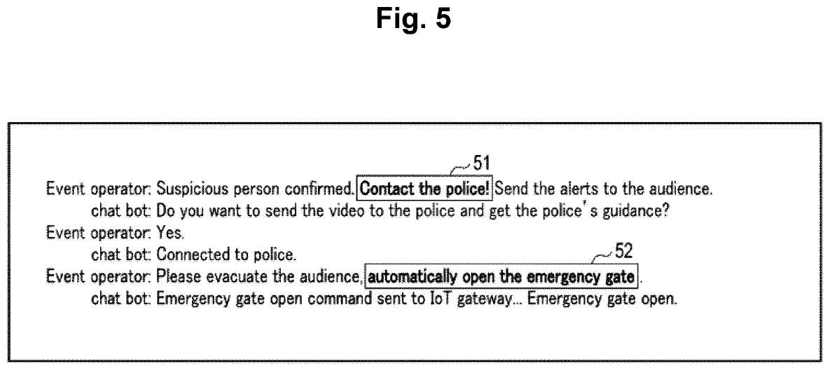

Next, FIG. 5 illustrates an analysis result of the intention of the user by the analysis unit 112.

Here, the analysis unit 112 further extracts a part to be an instruction by the user, a predicate, and an object from the dialog 40 illustrated in FIG. 4. Specifically, the analysis unit 112 extracts contents of an intention 51 “Contact the police!” and an intention 52 “automatically open the emergency gate” as the intention (instruction) of the user. Furthermore, the analysis unit 112 extracts “Contact” as a predicate and “police” as an object for the intention 51, and extracts “open” as a predicate and “emergency gate” as an object for the intention 52.

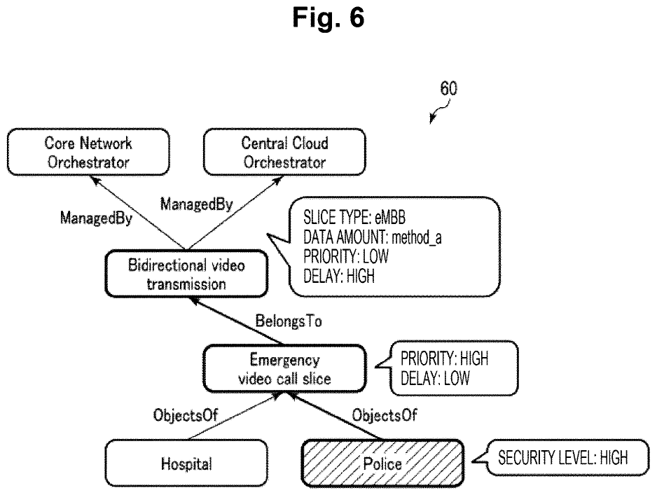

Next, a knowledge graph of a cloud domain to be searched is illustrated in FIG. 6.

A knowledge graph 60 shows services, service targets, and orchestrators related to a cloud domain. It is assumed that the knowledge graph 60 is generated in advance and stored in the storage unit 12. Here, there are “Police” and “Hospital” as service targets, and a node of “Emergency video call slice” is connected as a service of a higher layer by an edge indicating a relationship of “ObjectsOf” with these service targets. A node of “Bidirectional video transmission” is connected as a service of a higher layer by an edge indicating a relationship of “BelongsTo” with the service “Emergency video call slice”. A node of “Core Network Orchestrator” and a node of “Central Cloud Orchestrator” are connected as orchestrators of a higher layer by two edges indicating a relationship of “ManagedBy” with the service “Bidirectional video transmission”.

Here, since the object of “Police” is extracted in the intention 51 according to the analysis result in FIG. 5, it can be seen that the node of “Police” as the service target in the knowledge graph 60 is matched as the search result of the search unit 113. The search unit 113 searches for a service of a higher layer by tracing an edge of “ObjectsOf” from a node “Police” toward the higher layer. Here, the node of “Emergency video call slice” is selected as a service of the higher layer. Furthermore, the search unit 113 searches for a service of a higher layer by tracing the edge of “BelongsTo” from the node “Emergency video call slice” toward the higher layer. Here, the node of “Bidirectional video transmission” is selected as the service of the higher layer. Furthermore, the search unit 113 searches for an orchestrator of the higher layer by tracing the edge of “ManagedBy” from the node of “Bidirectional video transmission” toward the higher layer. Here, two orchestrators of “Core Network Orchestrator” and “Central Cloud Orchestrator” are selected as the orchestrator of the higher layer.

Subsequently, the determination unit 114 extracts a service requirement represented in advance as an attribute and a value thereof for each node of the service target “Police”, the service “Emergency video call slice”, and the service “Bidirectional video transmission”. Here, “security: high” is extracted as the service requirement of the service target “Police”. A service requirement of the service “Emergency video call slice” is a service requiring emergency, and “priority: high, delay: low” is extracted. The service requirement of the service “Bidirectional video transmission” is not a particularly emergency service, and “slice type: eMBB, data amount: method_a, priority: high, delay: low” is extracted.

Here, note that a plurality of values is calculated in a service requirement common to the service requirement of the service target “Emergency video call slice” and the service requirement of the service target “Bidirectional video transmission”. Specifically, the service target “Emergency video call slice” has “priority: high”, while the service target “Bidirectional video transmission” has “priority: low”. Moreover, the service target “Emergency video call slice” has “delay: low”, while the service target “Bidirectional video transmission” has “delay: high”. The determination unit 114 determines the highest value among the plurality of values as the value of the service requirement. Thus, the determination unit 114 determines a value of the service requirement “priority” as “high”, and determines a value of the service requirement “delay” as “low”.

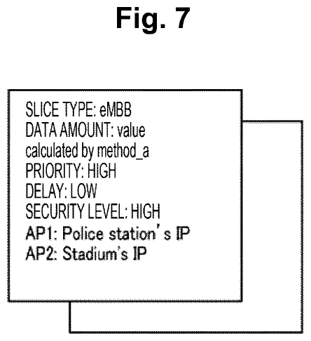

Next, an example of a determination result of the service requirement and a value thereof based on the knowledge graph 60 is illustrated in FIG. 7.

FIG. 7 is an example in which a service requirement and a value thereof determined by referring to the knowledge graph 60 of FIG. 6 are converted into a template format to an orchestrator. As illustrated in FIG. 7, “priority: high, delay: low” is determined as the service requirement and the value thereof. Note that conversion into the service requirement conforming to the orchestrator and the value thereof may be matched with the service requirement of the corresponding orchestrator by, for example, template matching, and a detailed description thereof is omitted here.

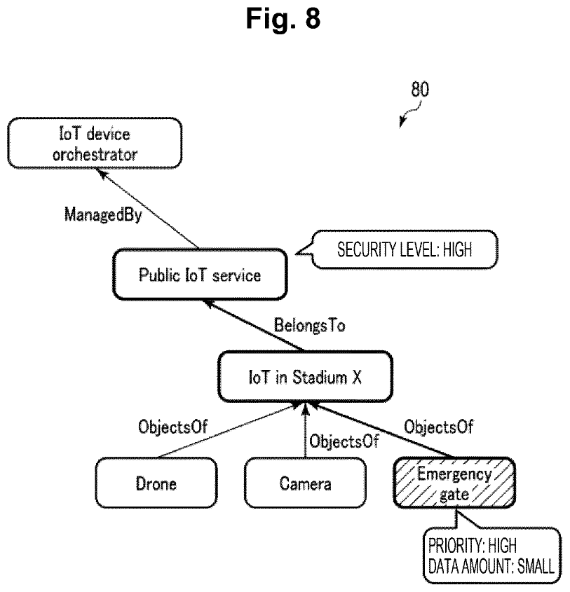

Next, a knowledge graph of an IoT domain to be searched is illustrated in FIG. 8.

A knowledge graph 80 shows services, service targets, and orchestrators related to an IoT domain. Here, there are nodes of “Drone”, “Camera”, and “Emergency gate” as service targets, and a node of “IOT in Stadium X” is connected as a service of a higher layer by an edge indicating a relationship of “ObjectsOf” with these service targets. A node of “Public IoT service” is connected as a service of a higher layer by an edge indicating a relationship of “BelongsTo” with the service “IoT in Stadium X”. A node of “IoT device orchestrator” is connected as an orchestrator of a higher layer by an edge indicating a relationship of “ManagedBy” with the service “Public IoT service”.

Here, since the object of “Emergency gate” is extracted in the intention 52 according to the analysis result of FIG. 5, it can be seen that the node of the service target “Emergency gate” in the knowledge graph 80 is matched as the search result of the search unit 113. The search unit 113 searches for a service of a higher layer by tracing an edge of “ObjectsOf” from a node “police” toward the higher layer. Here, the node of “IOT in Stadium X” is selected as the service of the higher layer. Furthermore, the search unit 113 searches for a service of a higher layer by tracing the edge of “BelongsTo” from the node “IOT in Stadium X” toward the higher layer. Here, the node of the “Public IoT service” is selected as the service of the higher layer. Furthermore, the search unit 113 searches for an Orchestrator of the higher layer by tracing the edge of “ManagedBy” from the node of “Public IoT service” toward the higher layer. Here, “IOT device orchestrator” is selected as the orchestrator of the higher layer.

Subsequently, the determination unit 114 extracts a service requirement represented in advance as an attribute and a value thereof for each node of the service target “Emergency gate”, the service “IOT in Stadium X”, and the service “Public IoT service”. Here, “priority: high, data amount: small” is extracted as the service requirement of the service target “Emergency gate”. Moreover, since the Service requirement of the service “Public IoT service” requires monitoring accuracy, “security level: high” is extracted.

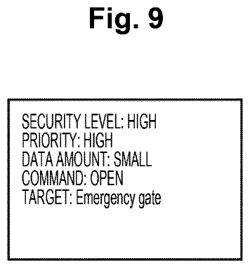

Next, an example of a determination result of a service requirement and a value thereof based on the knowledge graph 80 is illustrated in FIG. 9.

FIG. 9 is an example in which a service requirement and a value thereof extracted along FIG. 8 are converted into a template format to an orchestrator of “IoT device orchestrator”. Here, “security level: high, priority level: high, data amount: small, command: open, target: Emergency gate” is set as the service requirement for the orchestrator and the value thereof.

Note that, in a case where there is a plurality of nodes related to a service passing through the identified service or the node of the service target, there is a possibility that a contradiction occurs in the setting of the service requirement of the service. Thus, for example, the control unit 116 may notify the user of an alert indicating that there is a possibility that a contradiction has occurred.

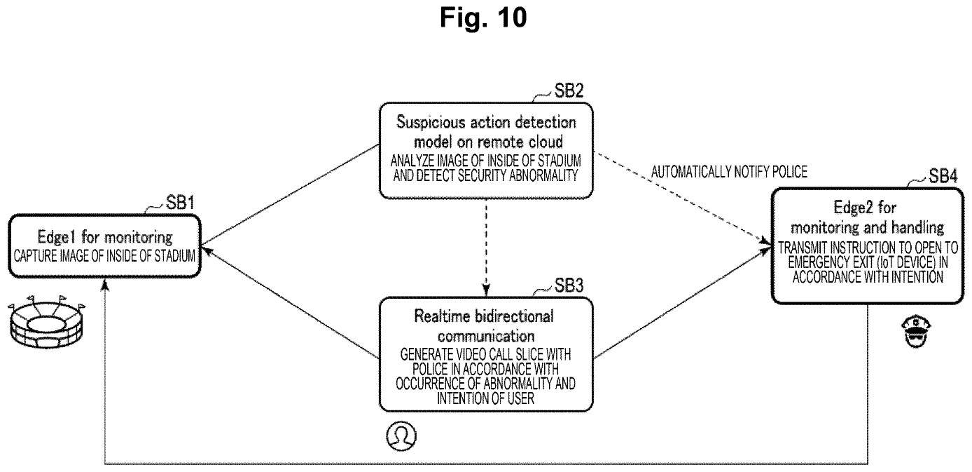

Next, an operation flow by the orchestrator, for which the service requirements illustrated in FIGS. 7 and 9 are set, will be described with reference to FIG. 10.

FIG. 10 illustrates a processing flow based on an event that has occurred, and includes an edge device (Edge 1) that monitors a stadium, an image analysis and a video call function using a cloud server, and an edge device (Edge 2) owned by the police.

In step SB1, an image of the inside of the stadium is captured in real time using, for example, a surveillance camera and a temperature camera as the edge device (Edge 1) for surveillance.

In step SB2, the captured image is subjected to image analysis to detect security abnormality such as presence of a suspicious person or a suspicious object.

In step SB3, if security abnormality is detected, a video call slice with the police is generated in accordance with the intention of the user, and a conversation is executed between the user and the police (police officer). Moreover, if security abnormality is detected, the police may be automatically notified from the cloud server.

In step SB4, an instruction to open an emergency exit (IoT device) controlled by the IoT device is transmitted in accordance with the intention. Note that, by the interaction between the user and the police officer in step SB3, an instruction to open the emergency exit may be transmitted in accordance with the instruction (or intention) of the user.

Note that, in a case where feedback is performed at the time of implementing a service as described above or a service is added in a domain, the update unit 115 may update the knowledge graph of each domain. For example, the update unit 115 may update nodes and edges with OpenCypher or the like, which is a graph database standard interface, regarding addition or change of services. For example, domain addition or change results in new addition or change of nodes and edges of orchestrators, services, and service targets. Moreover, the update unit 115 adds or changes the service target node and the accompanying node or edge by adding or changing the service type in an existing domain. Furthermore, service requirements may be added or changed to the existing knowledge graph.

According to the embodiment described above, the service is defined by three layers of “domain orchestrator/service/service target” using the knowledge graph. As a result, even for different services, since the services can be defined by the same description method, resource requirements can also be determined by the same method. That is, since it is unnecessary to consider a resource determination method for each domain, a service development period for developing a new service can be shortened. Furthermore, even in a case of developing a service that requires resource requirements of a plurality of different domains, the resource requirements can be determined at one time, and therefore, the larger the number of domains to be used, the further shortening in the service development period can be realized compared with the prior art. That is, it is possible to efficiently develop a service according to the intention of the use in a short period of time.

The instructions shown in the processing procedure illustrated in the above-described embodiment can be executed by a computer on the basis of a program as software.

In short, the present invention is not limited to the embodiment described above without any change, and can be embodied by modifying a component without departing from the gist of this invention at the implementation stage. Moreover, various inventions can be formed by suitably combining a plurality of components disclosed in the embodiment. For example, some components may be deleted from all the components illustrated in the embodiment. Furthermore, components in different embodiments may be suitably combined.

### REFERENCE SIGNS LIST

1 Information processing apparatus
11 Processing circuit
12 Storage unit
13 Communication interface
20 Node
21 Orchestrator
22 Service
23 Service target
25 Edge
40 Dialog
51, 52 Intention
60, 80 Knowledge graph
111 Acquisition unit
112 Analysis unit
113 Search unit
114 Determination unit
115 Update unit
116 Control unit

1. An information processing apparatus comprising a processor configured to:
analyze intention of a user;
search for a node corresponding to an analysis result of the intention in a knowledge graph, the knowledge graph being a graph in which a service, a service target to which the service is to be implemented, and an orchestrator related to operation management of the service and the service target are represented as nodes in different hierarchies and a relationship between nodes in different hierarchies or between nodes in a same hierarchy is represented as an edge; and
determine a type and a value of a service and a resource based on intention of the user by referring to the knowledge graph with reference to the corresponding node.

2. The information processing apparatus according to claim 1, wherein the knowledge graph is created for each of a plurality of different domains on a basis of a common creation criterion related to the node and the edge.

3. The information processing apparatus according to claim 1, wherein the processor is further configured to:
identify a node of the service or the service target related to intention of the user in the knowledge graph, and
determine the orchestrator by tracing a higher node with reference to the identified node.

4. The information processing apparatus according to claim 3, wherein the processor is configured to convert a type and a value of a service and a resource related to the identified service and service target to be used for operation of a higher node.

5. The information processing apparatus according to claim 1, wherein the processor is further configured to update a node and an edge of the knowledge graph in accordance with addition or change of the service or the service target, or change of a requirement of the resource.

6. The information processing apparatus according to claim 1, wherein the processor is configured to
identify a node of the service or the service target related to intention of the user in the knowledge graph, and
notify the user of an alert if a plurality of nodes related to a service passing through the identified node exist.

7. An information processing method comprising:
analyzing intention of a user;
searching for a node corresponding to an analysis result of the intention in a knowledge graph, the knowledge graph being a graph in which a service, a service target to which the service is to be implemented, and an orchestrator related to operation management of the service and the service target are represented as nodes in different hierarchies and a relationship between nodes in different hierarchies or between nodes in a same hierarchy is represented as an edge; and
determining a type and a value of a service and a resource based on intention of the user by referring to the knowledge graph with reference to the corresponding node.

8. A non-transitory computer readable medium including computer executable instructions, wherein the instructions, when executed by a processor, cause the processor to perform each process of the information processing apparatus according to claim 1.
